(19) United States
(12) Patent Application Publication
(10) Pub. No.: US 2022/0210492 A1
(43) Pub. Date: Jun. 30, 2022

(54) SYSTEMS AND METHODS FOR TRANSCODING CONTENT

(71) Applicant: Comcast Cable Communications, LLC, Philadelphia, PA (US)

(72) Inventor: Garey Hassler, Denver, CO (US)

(21) Appl. No.: 17/247,916

(22) Filed: Dec. 30, 2020

(51) Int. Cl. H04N 21/2343; H04N 21/647; H04N 21/262

(52) U.S. Cl. CPC H04N 21/234309; H04N 21/262; H04N 21/64738

(57) ABSTRACT

Based on content schedule data and a determined latency between initiation of transcoding and operation of transcoding, a lead time at which to initiate the transcoding process for content may be determined. Determining the latency between initiation of transcoding and operation of transcoding may comprise determining that at least one transcoder from a plurality of reserved transcoders is available to transcode the content and initiating the at least one transcoder, at the lead time, to transcode the content. Determining the latency between initiation of transcoding and operation of transcoding may comprise determining that at least one transcoder from a plurality of reserved transcoders is not available to transcode the content and initiating a transcoder associated with a cloud provider, at the lead time, to transcode the content.

### BACKGROUND

Content, such as linear content, may be viewed by a consumer at the time of broadcast. The consumer may expect that content is always available for viewing. However, a content provider may not find it advantageous to provide a continuous feed of content. For example, it may be expensive for the content provider to provide a continuous feed of video and audio. The consumer may also expect that playback of content is capable of starting almost instantaneously. However, a content provider may not be able to provide such immediate playback of content and this may result in a poor viewing experience. Therefore, improvements in content providing techniques are needed.

### SUMMARY

Methods and systems are disclosed for transcoding content. Content may be received. If it is determined that at least one transcoder from a plurality of reserved transcoders associated with a content provider is available to transcode the content, the at least one available transcoder may be initiated at a first time to transcode the first content. The first time may be determined by determining a latency between initiation of the at least one available transcoder and operation of the at least one available transcoder. If it is determined that at least one transcoder from a plurality of reserved transcoders associated with a content provider is not available to transcode the content, a transcoder associated with a cloud provider may be initiated at a second time to transcode the content. The second time may be determined by determining a latency between initiation of the transcoder associated with the cloud provider and operation of the transcoder associated with the cloud provider.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates a block diagram of an example environment according to an embodiment of the present disclosure;

FIG. 2 illustrates an example method according to an embodiment of the present disclosure;

FIG. 3 illustrates an example method according to an embodiment of the present disclosure;

FIG. 4 illustrates an example method according to an embodiment of the present disclosure;

FIG. 5 illustrates an example method according to an embodiment of the present disclosure;

FIG. 6 illustrates an example method according to an embodiment of the present disclosure; and

FIG. 7 illustrates a block diagram of an example computing device according to an embodiment of the present disclosure.

### DETAILED DESCRIPTION OF ILLUSTRATIVE EMBODIMENTS

To prepare content, such as linear content, for delivery to viewing devices, such as tablets, smartphones, PCs, or televisions, a content provider may need to perform several steps. For example, the content may need to be transcoded. Transcoding the content may be a two-step process in which the original content data is decoded to an intermediate uncompressed format, which is then encoded into the target content format. Once transcoded, the content may need to be packaged. Packaging the content may reshape the content so that it is suitable to reach viewers and their many devices. For example, a number of profiles may need to be created with different resolutions to accommodate varying screen sizes and different bitrates to match available bandwidth. Then each of these many profiles may be prepared or “packaged” for each adaptive bitrate streaming format, such as Apple HLS, Microsoft Smooth Streaming, Adobe HDS or MPEG DASH. The packaging step may also include encryption to enable security. These profiles, in each of the adaptive bitrate streaming formats, may be stored on a server to be delivered when the content is requested by a viewer. However, the storage of a large amount of content in a number of different formats may be expensive and use up significant bandwidth.

Just-in-time (“JIT”) transcoding and packaging techniques may be utilized to avoid storing a large amount of content in a number of different formats. A content provider that utilizes JIT transcoding and packaging may be able to transcode, package, and deliver content on the fly, rather than transcoding and packaging all of their content ahead of time. The transcoding and packaging of content may be performed only when that content is requested by a viewer, thereby saving storage and bandwidth. However, in reality, JIT transcoding and packaging is not “just-in-time.” The components responsible for transcoding and packaging content may take several minutes to actually become operational and service content to viewer devices.

Accordingly, it may be desirable to transcode content, such as linear content, while avoiding the difficulties described above. For example, it may be desirable to avoid the storage of a large amount of content in a number of different formats. To avoid the storage of a large amount of content, a content provider may utilize spot instance compute resources at cloud providers to transcode and package content. Such spot instance compute resources may be significantly cheaper for the content provider than owning its own physical resources. It may also be desirable to manage JIT transcoding and packaging for linear content so that content may actually be transcoded and packaged “just-in-time.” To manage JIT transcoding and packaging for linear content, scheduling information associated with the linear content may be utilized to commence the transcoding and packaging operations with sufficient lead time to have content available at the scheduled start time of the content.

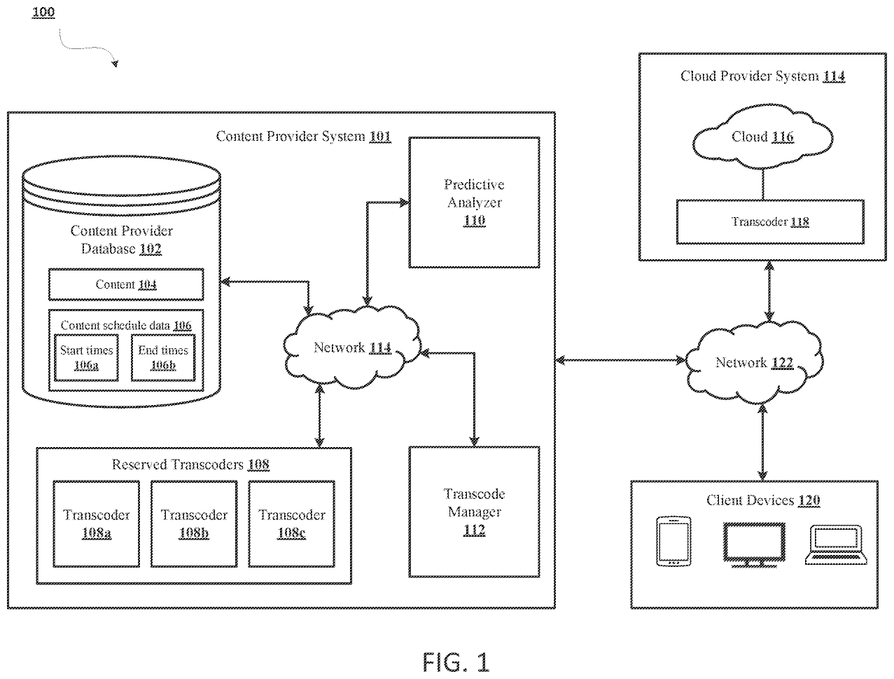

FIG. 1 illustrates an example hardware and network configuration 100 in which the systems and methods described herein may be implemented. Such a hardware and network configuration 100 may include a content provider system 101, a cloud provider system 115, and at least one device 120. The content provider system 101, the cloud provider system 115, and the at least one device 120 may be in communication via a network 122. The content provider system 101 may be associated with an individual or entity, such as a content provider, seeking to transcode content, such as linear content, while avoiding the difficulties described above. The content provider associated with the content provider system 101 may distribute transcoded and packaged content to the at least one device 120 for viewing.

The content provider system 101 may include a content provider database 102, a plurality of reserved transcoders 108, a predictive analyzer 110, and a transcoder manager 112. The content provider database 102, the plurality of reserved transcoders 108, the predictive analyzer 110, and the transcoder manager 112 may be in communication via a network 114.

The content provider database 102 may include content 104 and content schedule data 106. The content 104 may include, for example, video content, such as linear video content. Video content may refer generally to any video content produced for viewer consumption regardless of the type, format, genre, or delivery method. Video content may comprise video content produced for broadcast via over-the-air radio, cable, satellite, or the internet. Video content may comprise a movie, a television show or program, an episodic or serial television series, or a documentary series, such as a nature documentary series. As yet another example, video content may include a regularly scheduled video program series, such as a nightly news program. The content 104 may be associated with one or more content providers that distribute the content 104 to viewers for consumption. The content schedule data 106 may indicate schedule data associated with the content 104. For example, the content schedule data 106 may indicate at least one of a scheduled start time 106a, a scheduled end time 106b, or a scheduled duration associated with the content 104.

The plurality of reserved transcoders 108 may include any number of transcoders, such as the transcoders 108a-c. For example, the plurality of transcoders 108 may include ten transcoders or hundreds of transcoders. The plurality of reserved transcoders 108 may include transcoders owned by the content provider associated with the content provider system 101. The plurality of transcoders 108 may be used by the content provider to transcode content, such as the content 104, before it is packaged and distributed to viewers for consumption.

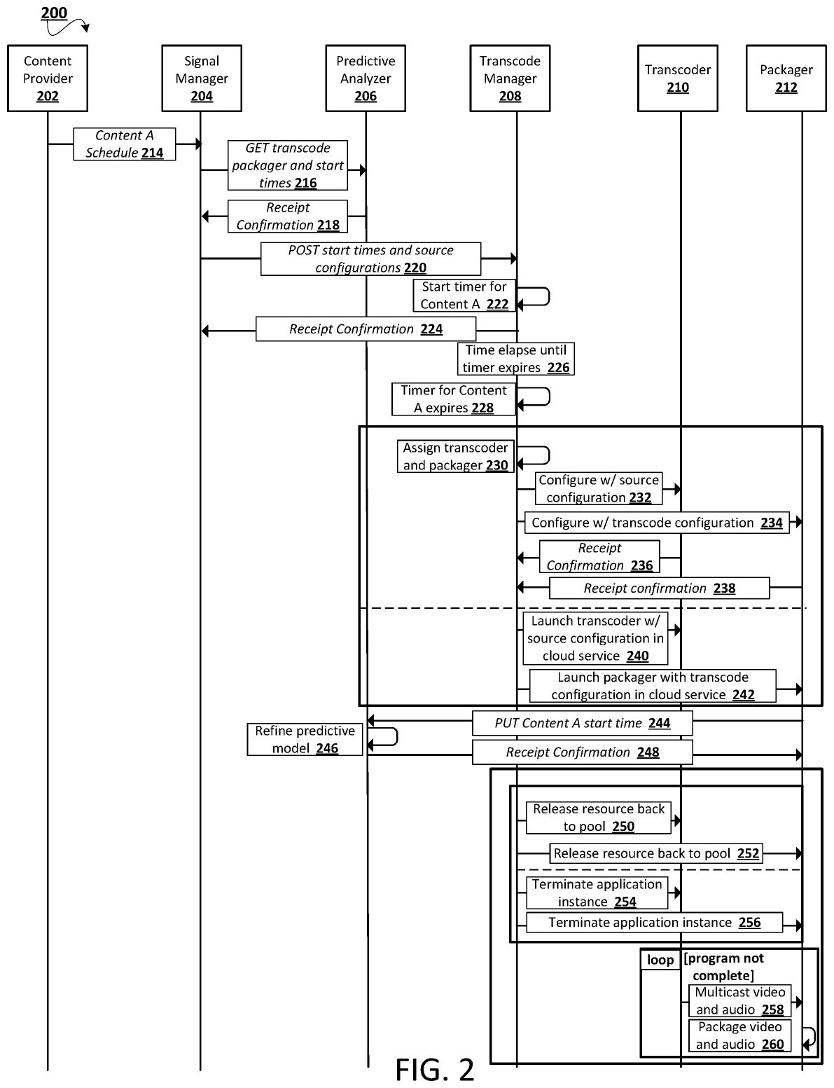

The predictive analyzer 110 and the transcoder manager 112 may be used, alone or in conjunction with one another, to manage transcoding of the content 104. For example, the content provider associated with the content provider system 101 may utilize at least one of the predictive analyzer 110 or the transcode manager 112 to manage transcoding, such as JIT transcoding, of the content 104 before it is packaged and distributed to viewers for consumption. The predictive analyzer 110 and the transcoder manager 112 may implement a number of the functions and techniques described herein. FIG. 2, described below, illustrates an exemplary flow diagram depicting a number of the functions and techniques implemented by the predictive analyzer 110 and the transcoder manager 112.

The cloud provider system 115 may include a cloud 116 and a transcoder 118. The cloud 116 may include at least one server that is accessed over the Internet and may include the software and databases that run on the at least one server. For example, the cloud 116 may include the transcoder 118. The transcoder 118 may be configured to run on the cloud 116. For example, the transcoder 118 may be configured to transcode content, such as the content 104, on the cloud. The transcoder 118 may be initiated via spot compute resources at the cloud provider.

The content provider database 102 may provide the content 104 or the content schedule data 106 to at least one of the predictive analyzer 110, the transcoder manager 112, the plurality of reserved transcoders 108, or the cloud provider system 115. The content provider database 102 may be integrated with one or more of the predictive analyzer 110, the transcoder manager 112, or the plurality of reserved transcoders 108. The network 114 or the network 122 may comprise one or more public networks (e.g., the Internet) and/or one or more private networks. A private network may include a wireless local area network (WLAN), a local area network (LAN), a wide area network (WAN), a cellular network, or an intranet. The network 114 or the network 122 may comprise wired network(s) and/or wireless network(s).

The content provider database 102, the predictive analyzer 110, the transcoder manager 112, the plurality of reserved transcoders 108, the cloud 116, the transcoder 118, and the at least one device 120 may each be implemented on the same or different computing devices. For example, the content provider database 102 can be located in a datastore of the same organization as the plurality of reserved transcoders 108, the predictive analyzer 110, or the transcoder manager 112, or in the datastore of a different organization. Such a computing device may comprise one or more processors and memory storing instructions that, when executed by the one or more processors, cause the computing device to perform one or more of the various methods or techniques described here. The memory may comprise volatile memory (e.g., random access memory (RAM)) and/or non-volatile memory (e.g., a hard or solid-state drive). The memory may comprise a non-transitory computer-readable medium.

FIG. 2 illustrates an exemplary method 200. The method 200 may be performed, for example, by the network configuration 100 of FIG. 1. The method 200 illustrates how a content provider, such as the content provider associated with the content provider system 101, may use a predictive analyzer, such as the predictive analyzer 110, and a transcode manager, such as the transcode manager 112 to manage transcoding of content, such as the content 104. A content provider may provide content schedule data, such as the content schedule data 106, to a signal manager. The signal manager may request, from the predictive analyzer, lead times indicative of how far in advance transcoding and packaging operations must be commenced in order to have content available at the scheduled start time of the content. If this request is successful, the signal manager may send the lead times and source configuration for the content to the transcode manager. The transcode manager may assign a transcoder and packager to each item of content and may ensure that transcoding of each item of content begins at the appropriate lead time and ends when the content is complete. Once a particular transcoder has completed the transcoding of a particular item of content, the transcode manager may re-assign that transcoder to different content.

A content provider may maintain a database including schedule data associated with the content that the content provider distributes to consumers for viewing. At step 214, a content provider 202 may send content schedule data to a signal manager 204. The content schedule data may indicate at least one of a scheduled start time associated with output of the content, a scheduled end time associated with output of the content, or a scheduled duration associated with output of the content. For example, the content schedule data associated with a particular item of content may indicate that output of that content is scheduled to start at 9:00 p.m. and is scheduled to end at 10:00 p.m. This content schedule data may be used, at least in part, to determine lead times indicative of how far in advance transcoding and packaging operations for a particular item of content must be commenced in order to have that content available at its scheduled start time.

A predictive analyzer 206 may be responsible for determining these lead times. At step 216, the signal manager 204 may request, from the predictive analyzer 206, lead times indicative of how far in advance transcoding and packaging operations must be commenced in order to have content available at the scheduled start time of the content. If the request for these lead times comprises an HTTP request, the request may identify the lead times via an HTTP GET method. The request may additionally or alternatively identify the lead times via any other suitable HTTP method. At step 218, the predictive analyzer 206 may send, to the signal manager 204, a receipt confirmation. The receipt confirmation may indicate that the request for the lead times was successful and the lead times may be transmitted in the message body of the receipt confirmation. If the request for these lead times comprises an HTTP request, the receipt confirmation may be a HTTP Status Code 200.

The predictive analyzer 206 may determine the lead times by determining a latency that will occur between the initiation of the transcoding process and the operation of the transcoding process. The latency may be indicative of how long it takes a transcoder to “warm up” and actually become operational. It may take longer to warm up a transcoder that is not local to the content provider. For example, it may take longer to warm up a transcoder associated with a cloud provider, such as the transcoder 118, than a transcoder that is associated with the content provider, such as the transcoders 108a-c. If a transcoder is local to the content provider, it may take a matter of seconds, such as ten seconds, for that transcoder to warm up and become operational. However, if a transcoder is not local to the content provider, it may take minutes, such as two to three minutes, for that transcoder to warm up and become operational. Additionally, even if a transcoder is local to the content provider, it may take minutes, such as two to three minutes, to warm up and become operational if that transcoder needs to be restarted. Accordingly, determining the latency between initiation of transcoding and operation of transcoding may comprise determining whether a transcoder local to the content provider is available to transcode the content, and if so, whether that transcoder needs to be restarted.

The predictive analyzer 206 may use the content schedule data and the determined latency, alone or in combination, to determine the lead time at which to initiate the transcoding process for content. The lead time may occur before the scheduled start time for output of the content. For example, if the content schedule data indicates that content is scheduled to start at 9:00 p.m., and a latency of three minutes between initiation of transcoding and operation of transcoding is determined, then it may be determined that the time at which to initiate transcoding of the content is 8:57 p.m. As another example, if the content schedule data indicates that content is scheduled to start at 9:00 p.m., and a latency of ten seconds between initiation of transcoding and operation of transcoding is determined, then it may be determined that the time at which to initiate transcoding of the content is ten seconds before 9:00 p.m.

At step 220, the signal manager 204 may send, to a transcode manager 208, the lead times and the source configurations associated with the content. The source configurations may be used by the transcode manager 208 to initiate a transcoder for transcoding the content. For example, the source configurations may be used by the transcode manager 208 to initiate, at the lead times, a transcoder for transcoding the content. If the lead times or source configurations are sent to the transcode manager 208 via an HTTP method, the lead times or source configurations may be sent to the transcode manager 208 via an HTTP POST method. The lead times or source configurations may additionally or alternatively be sent to the transcode manager 208 via any other suitable HTTP method.

The transcode manager 208 may use the lead times to set a timer for content. At step 222, the transcode manager 208 may start a timer for content. The timer may be set to start at the lead time. A transcoder may be initiated to transcode the content when the timer starts, and transcoding may continue until the timer expires. The timer may be set to expire when the content is complete, as indicated by the scheduled end time or the scheduled duration of the content. At step 224, the transcode manager 208 may send, to the signal manager 204, a receipt confirmation. The receipt confirmation may indicate that the lead times and source configurations were successfully received. If the lead times and source configurations were sent via an HTTP method, the receipt confirmation may be a HTTP Status Code 200. A transcoder may transcode the content until the timer expires. At step 226, time elapses until the timer expires. Time may elapse, for example, for the scheduled duration of the content. The timer may expire, for example, at the scheduled end time of the content. If the content is not complete at the scheduled end time, the timer may expire after the scheduled end time. At step 228, timer expires.

As discussed above, it may take longer to warm up a transcoder associated with a cloud provider, such as the transcoder 118, than a transcoder that is associated with the content provider, such as the transcoders 108a-c. Accordingly, for the predictive analyzer 206 to predict the lead time for a particular item of content, the predictive analyzer needs to know which transcoder is assigned to transcode that item of content At step 230, the transcoder manager 208 may assign a transcoder and packager to the content. The assigned transcoder may be a transcoder associated with the content provider, such as one of transcoders 108a-c, or may be a transcoder associated with a cloud provider, such as the transcoder 118. A content provider may prefer to transcode content on its own transcoders because the required lead time is less than it would be if the content was transcoded by a transcoder associated with a cloud provider. However, if all of the content provider's transcoders are consumed, then the content may need to be transcoded by a transcoder associated with a cloud provider.

If a transcoder associated with the content provider is available to transcode the content, then the transcoder associated with the content provider may be assigned to transcode the content. At step 232, the transcode manager 208 may configure the assigned transcoder associated with the content provider, such as the transcoder 210, with the source configuration. If the transcoder associated with the content provider is configured with the source configuration, the transcoder may initiate the transcoding process at the lead time. It may take minutes or seconds for the transcoder to warm up and become operational. At step 234, the transcode manager 208 may configure an assigned packager, such as the packager 212, with the transcode configuration. If the transcode manager 208 configures the assigned packager with the transcode configuration, the assigned packager may initiate the packaging process. It may take minutes or seconds for the packager to warm up and become operational.

The assigned transcoder and packager may send, to the transcode manager 208, a receipt confirmation. The receipt confirmation may indicate that the transcoder and packager were successfully configured. At step 236, a receipt confirmation may be sent from the transcoder 210 to the transcode manager 208. At step 238, a receipt confirmation may be sent from the packager 212 to the transcode manager 208. If the transcoder and packager received the source configurations via an HTTP method, the receipt confirmation may be a HTTP Status Code 200.

However, if a transcoder associated with the content provider is not available to transcode the content, then a transcoder associated with a cloud provider may be assigned to transcode the content. At step 240, the transcode manager 208 may launch a transcoder in the cloud service. The transcode manager 208 may configure the transcoder in the cloud service, such as the transcoder 210, with the source configuration. If the transcoder in the cloud service is configured with the source configuration, the transcoder in the cloud service may initiate the transcoding process at the lead time. It may take minutes or seconds for the transcoder to warm up and become operational. At step 242, the transcode manager 208 may launch a packager in the cloud service. The transcode manager 208 may configure the packager in the cloud service, such as the packager 212, with the transcode configuration. If the transcode manager 208 configures the assigned packager with the transcode configuration, the assigned packager may initiate the packaging process. It may take minutes or seconds for the packager to warm up and become operational.

At step 244, the assigned packager may send the start time associated with output of the content back to the predictive analyzer 206. If the start time associated with output of the content is sent to the predictive analyzer 206 via an HTTP method, the start time associated with output of the content may be sent to the predictive analyzer 206 via an HTTP PUT method. The start time associated with output of the content may additionally or alternatively be sent to the predictive analyzer 206 via any other suitable HTTP method. At step 246, the predictive analyzer 206 may use this received data to refine its predictive model. At step 248, a receipt confirmation may be sent from the predictive analyzer 206 to the assigned packager. If the predictive analyzer 206 received the start time associated with output of the content via an HTTP method, the receipt confirmation may be a HTTP Status Code 200.

The assigned transcoder associated with the content provider or with the cloud provider may transcode the content until the content is complete and the assigned packager associated with the content provider or with the cloud provider may package the content until the content is complete. When the content is complete, the transcoder may stop transcoding. If a transcoder associated with the content provider was assigned to transcode the content, at step 250, the assigned transcoder associated with the content provider may be released back to the pool of available transcoders. Similarly, when the content is complete, the packager may stop packaging. At step 252, the assigned packager associated with the content provider may be released back to the pool of available packagers. If a transcoder associated with the cloud provider was assigned to transcode the content, at step 254, the application instance associated with the transcoder may be terminated in the cloud. Similarly, when the content is complete, the packager may stop packaging. At step 256, the application instance associated with the packager may be terminated in the cloud. If the content is not completed at its scheduled end time, the transcoder and packager may need to continue transcoding and packaging after the scheduled end time.

If the transcoder and packager need to continue after the scheduled end time, at step 258, the transcoder 210 may continue to send content, such as multicast video and audio, to the packager 212 so that the packager 212 may continue packaging. At step 260, the packager 212 may package the content, such as the multicast video and audio, that it received from the transcoder 210.

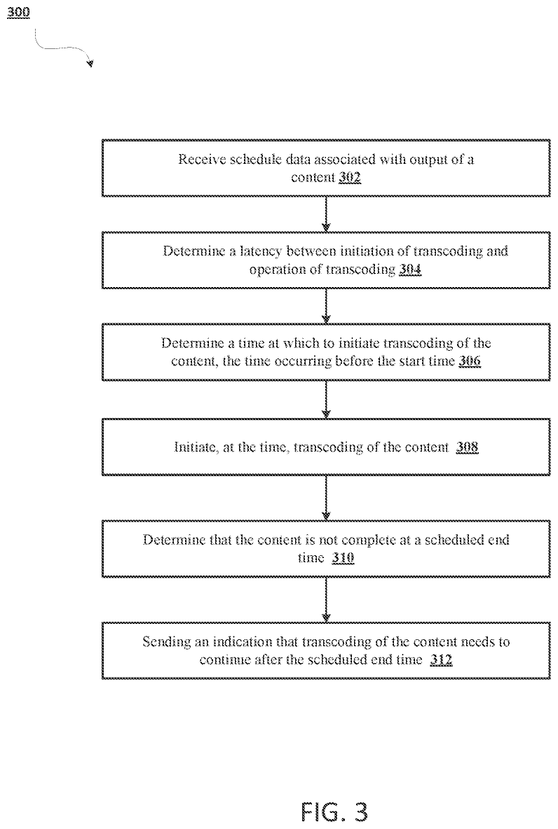

FIG. 3 illustrates an exemplary method 300 for transcoding content, such as the content 104 associated with FIG. 1. The method 300 may be performed, for example, by the network configuration 100 of FIG. 1. Schedule data, such as the content schedule data 106, associated with content, such as linear content, may be received. For example, the schedule data may indicate at least one of a scheduled start time, a scheduled end time, or a scheduled duration for output of the content. A lead time, indicative of how far in advance the transcoding and packaging operations must be commenced in order to have the content available at the scheduled start time of the content, may be determined. To determine the lead time, a latency between the initiation of the transcoding process and the operation of the transcoding process may be determined. For example, the latency may be indicative of how long it takes a transcoder to “warm up” and actually become operational. The amount of latency may be dependent on the location of the transcoder responsible for transcoding the content. For example, the lead time may be less if the transcoder is local to the content provider than if the transcoder is associated with a cloud provider. The transcoding and packaging operations may be initiated at the lead time.

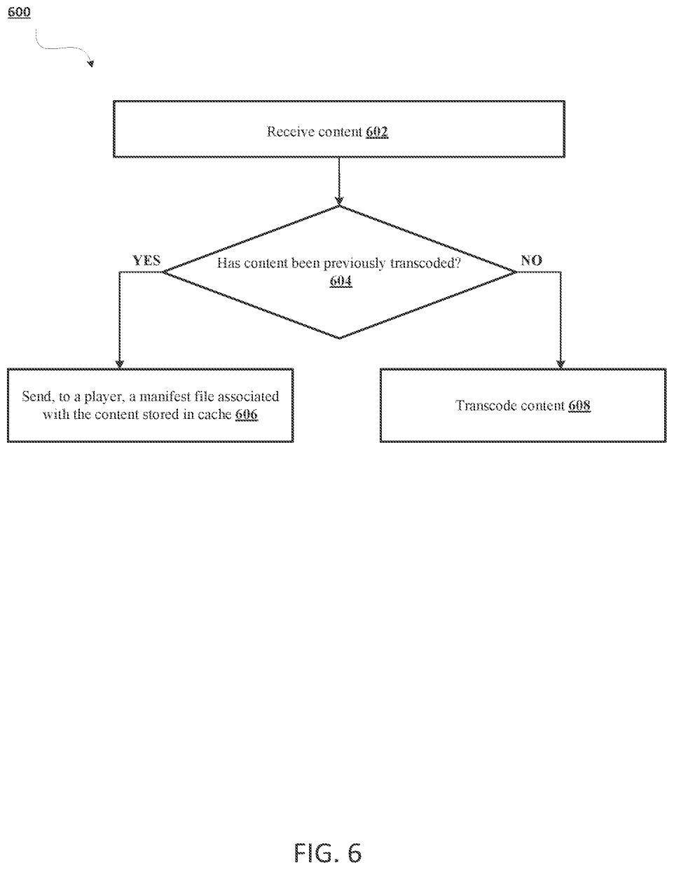

If content that is scheduled to be output has previously been transcoded, then that content may not need to be transcoded again. FIG. 6 illustrates an exemplary method 600 for determining if content needs to be transcoded. At step 602, content may be received. This content may have been previously transcoded. For example, a television program may be output multiple times per day or may already be stored in a video-on-demand (VOD) library. Such content may not need to be re-transcoded each time it is output in the future. At step 604, it may be determined if the content has been previously transcoded.

If the content has not been previously transcoded, the method 600 may proceed to step 606. Content that has previously been transcoded may be retrieved from cache or may be treated like a VOD asset. Overconsumption of computing resources may be minimized or prevented by transcoding content only once. If content has previously been transcoded and does not need to be transcoded again, a manifest file may be sent to a player responsible for output of that content. At step 606, a manifest file associated with the content stored in cache may be sent to the player responsible for output of the content. The manifest file may instruct the player to retrieve the already transcoded content from the content delivery network (CDN) and/or cache. Additional content, such as advertisements, may be inserted into the manifest file or replace other content. For example, if a content provider wants to insert additional content, such as advertisements, into the manifest file, the content provider may pull additional content, such as content from an advertisement library or repository, and insert it into the manifest file before it is sent to the player. In another example, if a content provider wants to replace content, such as advertisements, the manifest file may be updated to point to the new content, such as content from an advertisement library and repository.

Conversely, if the content has not been previously transcoded, the method may proceed to step 608. At step 608, the content may be transcoded and packaged, such as according to the method 300. For example, live content may not have been previously transcoded. If the content needs to be transcoded, a manifest file may be sent to a player responsible for output of that content. The manifest file may instruct the player to render the newly transcoded fragments. Additional content, such as advertisements, may be inserted into the manifest file. For example, if a content provider wants to insert additional content, such as advertisements, into the manifest file, the content provider may pull additional content, such as content from an advertisement library or repository, and insert it into the manifest file before it is sent to the player.

To determine if scheduled content has previously been transcoded, an identifier associated with each item of content, such as a program identifier, may be utilized. For example, the identifiers for all content that is scheduled to be output may be monitored. The identifiers may be indicative of whether scheduled content is new or whether scheduled content is a repeat or has already been transcoded. If the identifier associated with a particular item of scheduled content indicates that the content is not new or that it has already been transcoded, then that content may not need to be transcoded. Conversely, if the identifier associated with a particular item of scheduled content indicates that the content is new, then that content may need to be transcoded and packaged, such as according to the method 300.

At step 302, content schedule data, such as the content schedule data 106, may be received. The content schedule data may indicate at least one of scheduled start times, scheduled end times, or scheduled durations associated with output of the content, such as content 104. For example, the content schedule data may be received by a signal manager, such as the signal manager 204, associated with a content provider. The content schedule data may be forwarded from the signal manager to a predictive analyzer associated with the content provider, such as the predictive analyzer 110 or the predictive analyzer 206.

As discussed above, in reality, JIT transcoding and packaging is not “just-in-time.” The components responsible for transcoding and packaging content may take several minutes to actually become operational and service content to viewer devices. Accordingly, it may be desirable to determine a lead time at which to initiate the transcoding process so that the content is available at the scheduled start time of the content. In order to determine the lead time at which to initiate the transcoding process for content, a latency that will occur between the initiation of the transcoding process and the operation of the transcoding process may be determined.

At step 304, a latency between initiation of transcoding and operation of transcoding may be determined. For example, the latency between initiation of transcoding and operation of transcoding may be determined by a predictive analyzer, such as the predictive analyzer that received content schedule data from the signal manager. As discussed above, the latency may be indicative of how long it takes a transcoder to “warm up” and actually become operational. It may take longer to warm up a transcoder that is not local to the content provider. For example, it may take longer to warm up a transcoder associated with a cloud provider that is different than the content provider. If a transcoder is local to the content provider, it may take a matter of seconds, such as ten seconds, for that transcoder to warm up and become operational. However, if a transcoder is not local to the content provider, it may take minutes, such as two to three minutes, for that transcoder to warm up and become operational. Additionally, even if a transcoder is local to the content provider, it may take minutes, such as two to three minutes, to warm up and become operational if that transcoder needs to be restarted. Accordingly, determining the latency between initiation of transcoding and operation of transcoding may comprise determining whether a transcoder local to the content provider is available to transcode the content, and if so, whether that transcoder needs to be restarted.

It may also be desirable to determine a lead time at which to initiate the packaging process so that the content is available at the scheduled start time of the content. In order to determine the lead time at which to initiate the packaging process for content, a latency that will occur between the initiation of the packaging process and the operation of the packaging process may be determined. The latency may be indicative of how long it takes a packager to “warm up” and actually become operational.

The content schedule data and the determined latency may be used, alone or in combination, to determine the lead time at which to initiate the transcoding process for content. The lead times may be determined using a machine learning model. For example, the predictive analyzer may use a machine learning model to calculate and manage the lead times. The machine learning model may use, as input or training data, at least one of the content schedule data or the determined latency. The machine learning model may be refined each time the transcoding of an item of content begins using data regarding that transcoding.

The machine learning model may be trained, for example, using historic lead time data associated with transcoding content. The historic lead time data used to train the machine learning model may include network latency data obtained from other previously transcoded content. For example, the network latency data may include information indicative of the latency obtained from other previously transcoded content and may be reported by player analytic information. This network latency data may be associated with the transcoder that was responsible for transcoded the content, such as a transcoder local to the content provider or a transcoder associated with a cloud provider. For example, the network latency data may indicate a relationship between the latency associated with previously transcoded content and the location of the transcoder responsible for transcoding the content. The network latency data may additionally or alternatively indicate a relationship between the latency associated with previously transcoded content and any feature of the content, such as a duration of the content, type of content, a time of day that the content was transcoded, physical location of the transcoder, distance between the transcoder and the content source and/or the viewer, the format of the content being transcoded, and the like. Each time content is transcoded, the associated network latency data may be fed back into the machine learning model to improve the predictive analyzer's ability to predict appropriate lead times in the future.

At step 306, a time at which to initiate transcoding of the content may be determined. For example, the time at which to initiate the transcoding process for content may be determined by a predictive analyzer, such as the predictive analyzer that determined the latency between initiation of transcoding and operation of transcoding. The time may occur before the scheduled start time for output of the content. For example, if the content schedule data indicates that content is scheduled to start at 9:00 p.m., and a latency of three minutes between initiation of transcoding and operation of transcoding is determined, then it may be determined that the time at which to initiate transcoding of the content is 8:57 p.m. As another example, if the content schedule data indicates that content is scheduled to start at 9:00 p.m., and a latency of ten seconds between initiation of transcoding and operation of transcoding is determined, then it may be determined that the time at which to initiate transcoding of the content is ten seconds before 9:00 p.m.

The transcoding process may be initiated at the determined lead time so that the content is ready for viewing at the scheduled start time. At step 308, the transcoding process for the content may be initiated at the lead time. As discussed above, the transcoding process may be initiated before the scheduled start time of the content, so as to provide the transcoder ample time to warm up and become operational. Initiating the transcoding process for the content may comprise initiating a transcoder that is local to the content provider or initiating a transcoder associated with a cloud provider. If initiating the transcoding process comprises initiating a transcoder associated with a cloud provider, the transcoder may be initiated on a spot instance at the cloud provider.

The transcoding process for content may be initiated by a timer associated with the content. For example, a transcode manager, such as the transcode manager 112 or the transcode manager 208, may set a timer associated with the transcoding process for various content. The timer associated with a particular item of content may be set to start at the determined lead time, and may be set to expire at the scheduled end time of the content or set to expire after the schedule duration of the content, as indicated by the received content schedule data. Once the timer expires, transcoding and packaging of the content may stop and that particular transcoder and packager may be available to transcode and package a different item of content.

However, some content, such as a sports game, may run past the scheduled end time. At step 310, it may be determined that the content is not complete at the scheduled end time. If the content is not complete at the scheduled end time, transcoding of the content may need to continue after the scheduled end time. For example, transcoding of the content may need to continue after the timer associated with the content is set to expire. If transcoding of the content needs to continue after the scheduled end time, at step 312, an indication that transcoding of the content needs to continue after the scheduled end time may be sent. For example, the transcode manager may send, to the transcoder, an indication that transcoding of the content needs to continue after the scheduled end time. The transcode manager may also send, to the packager, an indication that packaging of the content needs to continue after the scheduled end time. Once the content is over, transcoding and packaging of the content may stop and that particular transcoder and packager may be available to transcode and package a different item of content.

The transcoding techniques described above may be used to initiate the transcoding process of content with sufficient lead time so as to ensure that content is available for viewing at its scheduled start time. However, a content provider may also desire to minimize the costs associated with transcoding and packaging content. Owning a large amount of physical resources for transcoding and packaging content may be expensive for a content provider, but a large amount of compute resources may be necessary in order to transcode and package all of the necessary content. To minimize the costs associated with transcoding and packaging content while also ensuring that sufficient compute resources are available for transcoding and packaging necessary content, a content provider may utilize spot instance computer resources at cloud providers.

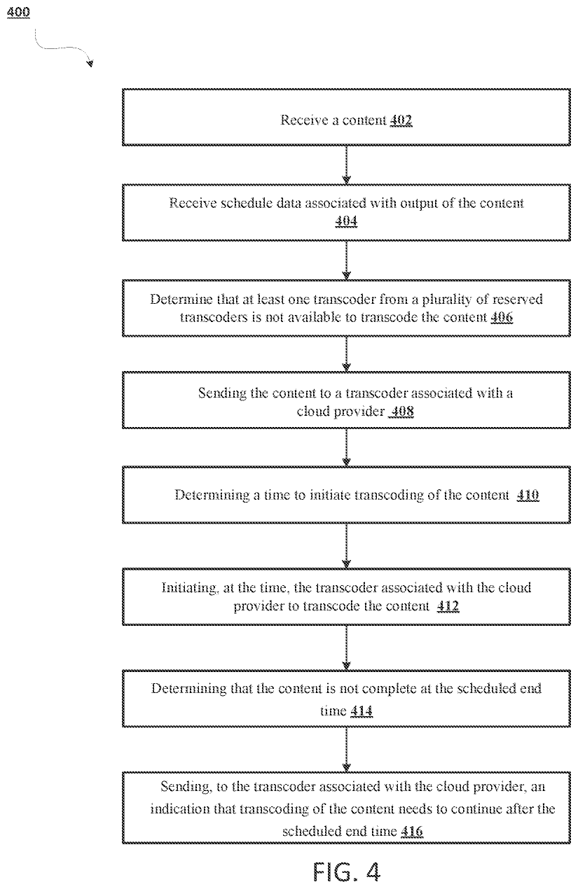

FIG. 4 illustrates an exemplary method 400 for transcoding content, such as the content 104 associated with FIG. 1. The method 400 may be performed, for example, by the network configuration 100 of FIG. 1. The method 400 may be used to minimize the costs associated with transcoding and packaging content by transcoding and packaging content on a spot instance at a cloud provider when compute resources local to the content provider are not available for transcoding and packaging. Transcoding of the content by the transcoder associated with the cloud provider may be initiated with sufficient lead time so as to ensure that the content is available for viewing at its scheduled start time. As discussed above, this lead time may be greater than the lead time that would have been needed if the content was transcoded by a transcoder local to the content provider.

If content that is scheduled to be output has previously been transcoded, then that content may not need to be transcoded again. FIG. 6 illustrates an exemplary method 600 for determining if content needs to be transcoded. At step 602, content may be received. This content may have been previously transcoded. For example, a television program may be output multiple times per day or may already be stored in a video-on-demand (VOD) library. Such content may not need to be re-transcoded each time it is output in the future. At step 604, it may be determined if the content has been previously transcoded.

If the content has not been previously transcoded, the method 600 may proceed to step 606. Content that has previously been transcoded may be retrieved from cache or may be treated like a VOD asset. Overconsumption of computing resources may be minimized or prevented by transcoding content only once. If content has previously been transcoded and does not need to be transcoded again, a manifest file may be sent to a player responsible for output of that content. At step 606, a manifest file associated with the content stored in cache may be sent to the player responsible for output of the content. The manifest file may instruct the player to retrieve the already transcoded content from the content delivery network (CDN) and/or cache. Additional content, such as advertisements, may be inserted into the manifest file or replace other content. For example, if a content provider wants to insert additional content, such as advertisements, into the manifest file, the content provider may pull additional content, such as content from an advertisement library or repository, and insert it into the manifest file before it is sent to the player. In another example, if a content provider wants to replace content, such as advertisements, the manifest file may be updated to point to the new content, such as content from an advertisement library and repository.

Conversely, if the content has not been previously transcoded, the method may proceed to step 608. At step 608, the content may be transcoded and packaged, such as according to the method 400. For example, live content may not have been previously transcoded. If the content needs to be transcoded, a manifest file may be sent to a player responsible for output of that content. The manifest file may instruct the player to render the newly transcoded fragments. Additional content, such as advertisements, may be inserted into the manifest file. For example, if a content provider wants to insert additional content, such as advertisements, into the manifest file, the content provider may pull additional content, such as content from an advertisement library or repository, and insert it into the manifest file before it is sent to the player.

To determine if scheduled content has previously been transcoded, an identifier associated with each item of content, such as a program identifier, may be utilized. For example, the identifiers for all content that is scheduled to be output may be monitored. The identifiers may be indicative of whether scheduled content is new or whether scheduled content has already been transcoded. If the identifier associated with a particular item of scheduled content indicates that the content is not new or that it has already been transcoded, then that content may not need to be transcoded. Conversely, if the identifier associated with a particular item of scheduled content indicates that the content is new, then that content may need to be transcoded and packaged, such as according to the method 400.

A content provider may need to transcode and package content for distribution to viewers. At step 402, content, such as the content 104, may be received. The content may include, for example, video content, such as linear video content. Video content may refer generally to any video content produced for viewer consumption regardless of the type, format, genre, or delivery method. Video content may comprise video content produced for broadcast via over-the-air radio, cable, satellite, or the internet. Video content may comprise a movie, a television show or program, an episodic or serial television series, or a documentary series, such as a nature documentary series. As yet another example, video content may include a regularly scheduled video program series, such as a nightly news program. The content may be associated with content schedule data, such as the content schedule data 106. At step 404, scheduled data associated with output of the content may be received. The scheduled data associated with output of the content that may indicate at least one of a scheduled start time, a scheduled end time, or a scheduled duration associated with output of the content.

The content provider may own a certain amount of physical resources that are capable of transcoding and packaging content before it is distributed to viewers for consumption. For example, the content provider may own a plurality of reserved transcoders, such as the plurality of transcoders 108 of FIG. 1. However, if all of the content provider's physical resources that are capable of transcoding and packaging content are already being consumed, additional content that needs to be transcoded and packaged may need to be transcoded by different compute resources. At step 406, it may be determined that at least one transcoder from a plurality of reserved transcoders is not available to transcode the content. For example, at least one transcoder from the plurality of reserved transcoders may not be available to transcode the content if each of the plurality of reserved transcoders is already transcoding other content.

If at least one transcoder from a plurality of reserved transcoders is not available to transcode the content, the content may need to be transcoded by different compute resources, such as a transcoder associated with a cloud provider. At step 408, the content may be sent to a transcoder associated with a cloud provider. The transcoder associated with the cloud provider may be part of a system that is different than the content provider. For example, the transcoder associated with the cloud provider may be associated with the cloud provider system 115 of FIG. 1 and the content provider as well as the plurality of reserved transcoders may be associated with the content provider system 101 of FIG. 1.

As discussed above, in reality, JIT transcoding and packaging is not “just-in-time.” The components responsible for transcoding and packaging content may take several minutes to actually become operational and service content to viewer devices. Accordingly, it may be desirable to determine a lead time at which to initiate the transcoding process so that the content is available at the scheduled start time of the content. In order to determine the lead time at which to initiate the transcoding process for content, a latency that will occur between the initiation of the transcoding process and the operation of the transcoding process may be determined.

At step 410, a time at which to initiate transcoding of the content may be determined. To determine the time at which to initiate transcoding of the content, a latency between initiation of transcoding and operation of transcoding may be determined. For example, the latency between initiation of transcoding and operation of transcoding may be determined by a predictive analyzer, such as the predictive analyzer that received content schedule data from the signal manager. As discussed above, the latency may be indicative of how long it takes a transcoder to “warm up” and actually become operational. It may take longer to warm up a transcoder that is not local to the content provider. For example, it may take longer to warm up a transcoder associated with a cloud provider that is different than the content provider. If a transcoder is local to the content provider, it may take a matter of seconds, such as ten seconds, for that transcoder to warm up and become operational. However, if a transcoder is not local to the content provider, it may take minutes, such as two to three minutes, for that transcoder to warm up and become operational.

It may also be desirable to determine a lead time at which to initiate the packaging process so that the content is available at the scheduled start time of the content. In order to determine the lead time at which to initiate the packaging process for content, a latency that will occur between the initiation of the packaging process and the operation of the packaging process may be determined. The latency may be indicative of how long it takes a packager to “warm up” and actually become operational.

The content schedule data and the determined latency may be used, alone or in combination, to determine the lead time at which to initiate the transcoding process for content. For example, the time at which to initiate the transcoding process for content may be determined by a predictive analyzer, such as the predictive analyzer that determined the latency between initiation of transcoding and operation of transcoding. The time may occur before the scheduled start time for output of the content. For example, if the content schedule data indicates that content is scheduled to start at 9:00 p.m., and a latency of three minutes between initiation of transcoding and operation of transcoding is determined, then it may be determined that the time at which to initiate transcoding of the content is 8:57 p.m.

As discussed above, the lead times may be determined using a machine learning model. For example, the predictive analyzer may use a machine learning model to calculate and manage the lead times. The machine learning model may use, as input or training data, at least one of the content schedule data or the determined latency. The machine learning model may be trained, for example, using historic lead time data associated with transcoding content. The machine learning model may be refined each time the transcoding of an item of content begins using data regarding that transcoding.

The machine learning model may be trained, for example, using historic lead time data associated with transcoding content. The historic lead time data used to train the machine learning model may include network latency data obtained from other previously transcoded content. For example, the network latency data may include information indicative of the latency obtained from other previously transcoded content and may be reported by player analytic information. This network latency data may be associated with the transcoder that was responsible for transcoded the content, such as a transcoder local to the content provider or a transcoder associated with a cloud provider. For example, the network latency data may indicate a relationship between the latency associated with previously transcoded content and the location of the transcoder responsible for transcoding the content. The network latency data may additionally or alternatively indicate a relationship between the latency associated with previously transcoded content and any feature of the content, such as a duration of the content, type of content, or a time of day that the content was transcoded, physical location of the transcoder, distance between the transcoder and the content source and/or the viewer, the format of the content being transcoded, and the like. Each time content is transcoded, the associated network latency data may be fed back into the machine learning model to improve the predictive analyzer's ability to predict appropriate lead times in the future.

The transcoding process may be initiated at the determined lead time so that the content is ready for viewing at the scheduled start time. At step 412, the transcoder associated with the cloud provider may be initiated at the time. As discussed above, the transcoding process may be initiated before the scheduled start time of the content, so as to provide the transcoder ample time to warm up and become operational. Initiating the transcoding process for the content may comprise initiating the transcoder associated with a cloud provider, such as on a spot instance at the cloud provider.

The transcoding process for content may be initiated by a timer associated with the content. For example, a transcode manager, such as the transcode manager 112 or the transcode manager 208, may set a timer associated with the transcoding process for various content. The timer associated with a particular item of content may be set to start at the determined lead time, and may be set to expire at the scheduled end time of the content or set to expire after the schedule duration of the content, as indicated by the received content schedule data. Once the timer expires, transcoding and packaging of the content may stop.

However, some content, such as a sports game, may run past the scheduled end time. At step 414, it may be determined that the content is not complete at its scheduled end time. If the content is not complete at the scheduled end time, transcoding of the content may need to continue after the scheduled end time. For example, transcoding of the content may need to continue after the timer associated with the content is set to expire. If transcoding of the content needs to continue after the scheduled end time, at step 416, an indication that transcoding of the content needs to continue after the scheduled end time may be sent. For example, the transcode manager may send, to the transcoder associated with the cloud provider, an indication that transcoding of the content needs to continue after the scheduled end time. Once the content is over, transcoding and packaging of the content may stop.

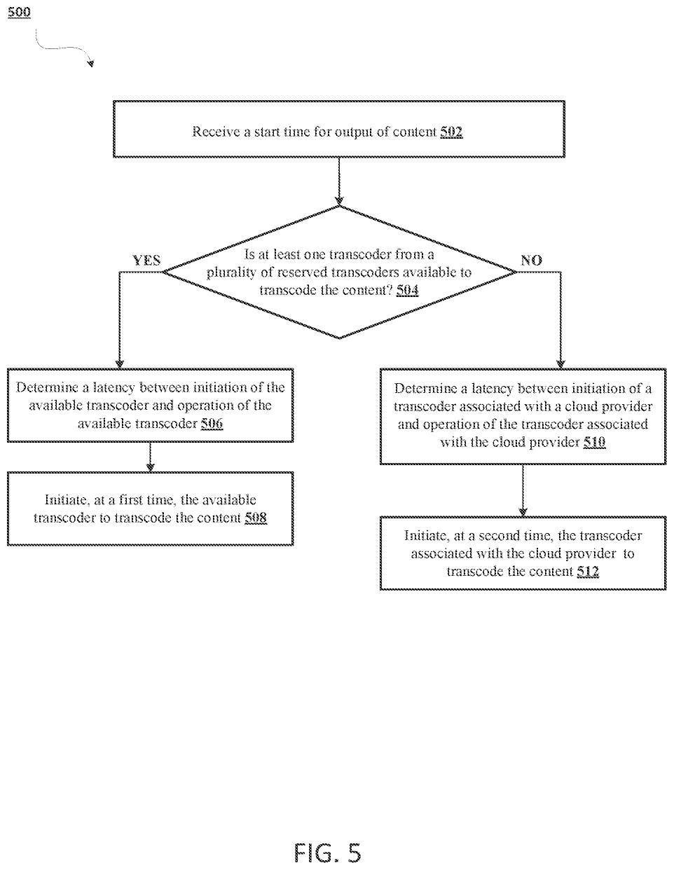

As discussed above with respect to methods 300 and 400, it may be desirable to initiate the transcoding process of content with sufficient lead time so as to ensure that content is available for viewing at its scheduled start time and it may also be desirable to minimize the costs associated with transcoding and packaging content. Accordingly, it may be desirable to initiate the transcoding process of content with sufficient lead time so as to ensure that content is available for viewing at its scheduled start time while simultaneously minimizing the costs associated with transcoding and packaging content. FIG. 5 illustrates an exemplary method 500 for transcoding content, such as the content 104 associated with FIG. 1. The method 500 may be performed, for example, by the network configuration 100 of FIG. 1. The method 500 may be used to simultaneously initiate the transcoding process of content with sufficient lead time and minimize the costs associated with transcoding and packaging content.

If content that is scheduled to be output has previously been transcoded, then that content may not need to be transcoded again. FIG. 6 illustrates an exemplary method 600 for determining if content needs to be transcoded. At step 602, content may be received. This content may have been previously transcoded. For example, a television program may be output multiple times per day or may already be stored in a video-on-demand (VOD) library. Such content may not need to be re-transcoded each time it is output in the future. At step 604, it may be determined if the content has been previously transcoded.

If the content has not been previously transcoded, the method 600 may proceed to step 606. Content that has previously been transcoded may be retrieved from cache or may be treated like a VOD asset. Overconsumption of computing resources may be minimized or prevented by transcoding content only once. If content has previously been transcoded and does not need to be transcoded again, a manifest file may be sent to a player responsible for output of that content. At step 606, a manifest file associated with the content stored in cache may be sent to the player responsible for output of the content. The manifest file may instruct the player to retrieve the already transcoded content from the content delivery network (CDN) and/or cache. Additional content, such as advertisements, may be inserted into the manifest file or replace other content. For example, if a content provider wants to insert additional content, such as advertisements, into the manifest file, the content provider may pull additional content, such as content from an advertisement library or repository, and insert it into the manifest file before it is sent to the player. In another example, if a content provider wants to replace content, such as advertisements, the manifest file may be updated to point to the new content, such as content from an advertisement library and repository.

Conversely, if the content has not been previously transcoded, the method may proceed to step 608. At step 608, the content may be transcoded and packaged, such as according to the method 500. For example, live content may not have been previously transcoded. If the content needs to be transcoded, a manifest file may be sent to a player responsible for output of that content. The manifest file may instruct the player to render the newly transcoded fragments. Additional content, such as advertisements, may be inserted into the manifest file. For example, if a content provider wants to insert additional content, such as advertisements, into the manifest file, the content provider may pull additional content, such as content from an advertisement library or repository, and insert it into the manifest file before it is sent to the player.

To determine if scheduled content has previously been transcoded, an identifier associated with each item of content, such as a program identifier, may be utilized. For example, the identifiers for all content that is scheduled to be output may be monitored. The identifiers may be indicative of whether scheduled content is new or whether scheduled content is a repeat or has already been transcoded. If the identifier associated with a particular item of scheduled content indicates that the content is not new or that it has already been transcoded, then that content may not need to be transcoded. Conversely, if the identifier associated with a particular item of scheduled content indicates that the content is new, then that content may need to be transcoded and packaged, such as according to the method 500.

At step 502, content schedule data, such as the content schedule data 106, may be received. The content schedule data may indicate at least one of scheduled start times, scheduled end times, or scheduled durations associated with output of the content, such as content 104. For example, the content schedule data may be received by a signal manager, such as the signal manager 204, associated with a content provider. The content schedule data may be forwarded from the signal manager to a predictive analyzer associated with the content provider, such as the predictive analyzer 110 or the predictive analyzer 206.

As discussed above, the content provider may own a certain amount of physical resources that are capable of transcoding and packaging content before it is distributed to viewers for consumption. For example, the content provider may own a plurality of reserved transcoders, such as the plurality of transcoders 108 of FIG. 1. The content provider may also utilize a private cloud to transcode and package content before it is distributed to viewers. For example, the content provider may utilize shared computing resources allocated within a public cloud environment, with a level of isolation between the different organizations using the resources. However, if all of the content provider's physical resources or if all of the shared resources in the private cloud are already being consumed, any additional content that needs to be transcoded and packaged may need to be transcoded by different compute resources. At step 504, it may be determined if at least one transcoder from a plurality of reserved transcoders is available to transcode the content. If at least one transcoder from a plurality of reserved transcoders is available to transcode the content, the method 500 may proceed to step 506. Conversely, if at least one transcoder from a plurality of reserved transcoders is not available to transcode the content, the method 500 may proceed to step 510.

As also discussed above, JIT transcoding and packaging is, in reality, not “just-in-time.” The components responsible for transcoding and packaging content may take several minutes to actually become operational and service content to viewer devices. Accordingly, it may be desirable to determine a lead time at which to initiate the transcoding process so that the content is available at the scheduled start time of the content. In order to determine the lead time at which to initiate the transcoding process for content, a latency that will occur between the initiation of the transcoding process and the operation of the transcoding process may be determined.

If at least one transcoder from a plurality of reserved transcoders is available to transcode the content, a lead time at which to initiate the available transcoder so that the content is available at its scheduled start time may be determined. At step 506, a latency between initiation of the available transcoder and operation of the available transcoder may be determined. For example, the latency between initiation of transcoding and operation of transcoding may be determined by a predictive analyzer, such as the predictive analyzer that received content schedule data from the signal manager. As discussed above, the latency may be indicative of how long it takes a transcoder to “warm up” and actually become operational. If a transcoder is local to the content provider, it may take a matter of seconds, such as ten seconds, for that transcoder to warm up and become operational. Even if a transcoder is local to the content provider, it may take minutes, such as two to three minutes, to warm up and become operational if that transcoder needs to be restarted. Accordingly, determining the latency between initiation of the available transcoder and operation of the available transcoder may comprise determining whether that transcoder needs to be restarted.

It may also be desirable to determine a lead time at which to initiate the packaging process so that the content is available at the scheduled start time of the content. In order to determine the lead time at which to initiate the packaging process for content, a latency that will occur between the initiation of the packaging process and the operation of the packaging process may be determined. The latency may be indicative of how long it takes a packager to “warm up” and actually become operational. The latency that will occur between the initiation of the packaging process and the operation of the packaging process may be different or the same as the latency between initiation of the available transcoder and operation of the available transcoder. For example, the transcoder may need more time to “warm up” than the packager does.

The content schedule data and the determined latency may be used, alone or in combination, to determine the lead time, such as a first time, at which to initiate the available transcoder for transcoding the content. The content schedule data and the determined latency may also be used, alone or in combination, to determine the lead time at which to initiate the available packager for packaging the content. If the transcoder needs more time to “warm up” than the packager does, the lead time at which to initiate the available transcoder may be greater than the lead time at which to initiate the available packager. For example, the transcoder may need three minutes to warm up and the packager may need two minutes to warm up. If the transcoder needs three minutes to warm up and the packager needs two minutes to warm up, the transcoder may need to be initiated at a lead time of three minutes before the scheduled start time and the packager may need to be initiated at a lead time of two minutes before the scheduled start time.

As discussed above, the lead times may be determined using a machine learning model. For example, the predictive analyzer may use a machine learning model to calculate and manage the lead times. The machine learning model may use, as input or training data, at least one of the content schedule data or the determined latency. The machine learning model may be trained, for example, using historic lead time data associated with transcoding content. The machine learning model may be refined each time the transcoding of an item of content begins using data regarding that transcoding.

The machine learning model may be trained, for example, using historic lead time data associated with transcoding content. The historic lead time data used to train the machine learning model may include network latency data obtained from other previously transcoded content. For example, the network latency data may include information indicative of the latency obtained from other previously transcoded content and may be reported by player analytic information. This network latency data may be associated with the transcoder that was responsible for transcoded the content, such as a transcoder local to the content provider or a transcoder associated with a cloud provider. For example, the network latency data may indicate a relationship between the latency associated with previously transcoded content and the location of the transcoder responsible for transcoding the content. The network latency data may additionally or alternatively indicate a relationship between the latency associated with previously transcoded content and any feature of the content, such as a duration of the content or a time of day that the content, type of content, or a time of day that the content was transcoded, physical location of the transcoder, distance between the transcoder and the content source and/or the viewer, the format of the content being transcoded, and the like. Each time content is transcoded, the associated network latency data may be fed back into the machine learning model to improve the predictive analyzer's ability to predict appropriate lead times in the future.

At step 508, the available transcoder may be initiated, at the lead time, to transcode the content. As discussed above, the transcoding process may be initiated before the scheduled start time of the content, so as to provide the available transcoder ample time to warm up and become operational. If a lead time at which to initiate the packaging process was also determined, the available packager may also be initiated at the appropriate lead time.

If at least one transcoder from a plurality of reserved transcoders is not available to transcode the content, that content may need to be transcoded by a transcoder associated with a cloud provider. If the content needs to be transcoded by a transcoder associated with a cloud provider, a lead time at which to initiate the transcoder associated with a cloud provider so that the content is available at its scheduled start time may be determined. At step 510, a latency between initiation of a transcoder associated with a cloud provider and operation of the transcoder associated with a cloud provider may be determined. For example, the latency between initiation of transcoding and operation of transcoding may be determined by a predictive analyzer, such as the predictive analyzer that received content schedule data from the signal manager. As discussed above, the latency may be indicative of how long it takes a transcoder to “warm up” and actually become operational. It may take longer to warm up a transcoder associated with a cloud provider than a transcoder that is local to the content provider, such as one of the reserved transcoders. While a transcoder that is local to the content provider, may take a matter of seconds to warm up and become operational, a transcoder associated with a cloud provider may take minutes, such as two to three minutes, to warm up and become operational.

The content schedule data and the determined latency may be used, alone or in combination, to determine the lead time, such as a second time, at which to initiate the transcoder associated with the cloud provider for transcoding the content. At step 512, the transcoder associated with the cloud provider may be initiated, at the lead time, to transcode the content. As discussed above, the transcoding process may be initiated before the scheduled start time of the content, so as to provide the available transcoder ample time to warm up and become operational. Because it may take longer to warm up a transcoder associated with a cloud provider than a transcoder that is local to the content provider, the content that is transcoded by the transcoder associated with a cloud provider may need a greater lead time than the content that is transcoded by one of the plurality of reserved transcoders. Accordingly, the difference between the first time and the start time for output of the content transcoded by one of the plurality of reserved transcoders may be less than the difference between the second time and the start time for output of the content transcoded in the cloud.

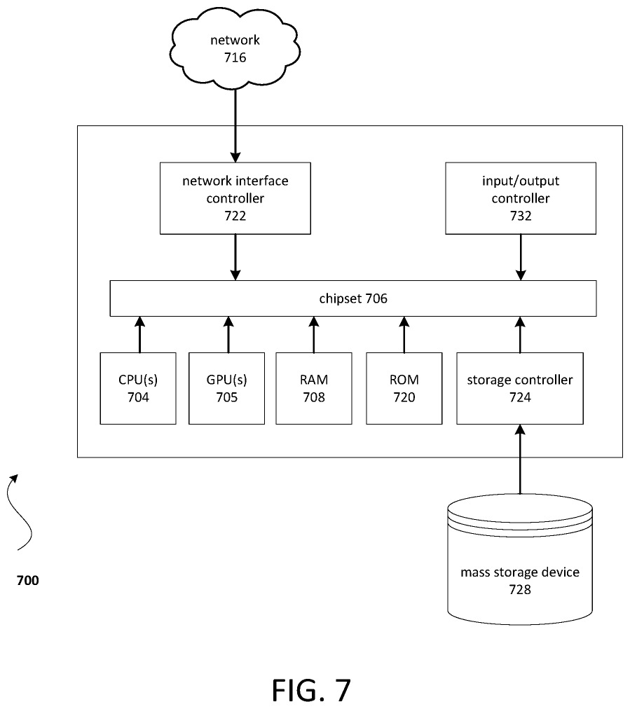

FIG. 7 depicts a computing device that may be used in various aspects. With regard to the example environment of FIG. 1, one or more of the content provider database 102, the plurality of reserved transcoders 108, the predictive analyzer 110, the transcoder manager 112, the transcoder 118, or the at least one device 120 may be implemented in an instance of a computing device 700 of FIG. 7. The computer architecture shown in FIG. 7 shows a conventional server computer, workstation, desktop computer, laptop, tablet, network appliance, PDA, e-reader, digital cellular phone, or other computing node, and may be utilized to execute any aspects of the computers described herein, such as to implement the methods described in FIGS. 3-6.

The computing device 700 may include a baseboard, or “motherboard,” which is a printed circuit board to which a multitude of components or devices may be connected by way of a system bus or other electrical communication paths. One or more central processing units (CPUs) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 704 may be augmented with or replaced by other processing units, such as GPU(s) 705. The GPU(s) 705 may comprise processing units specialized for but not necessarily limited to highly parallel computations, such as graphics and other visualization-related processing.

A user interface may be provided between the CPU(s) 704 and the remainder of the components and devices on the baseboard. The interface may be used to access a random-access memory (RAM) 708 used as the main memory in the computing device 700. The interface may be used to access a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein. The user interface may be provided by a one or more electrical components such as the chipset 706.

The computing device 700 may operate in a networked environment using logical connections to remote computing nodes and computer systems through local area network (LAN) 716. The chipset 706 may include functionality for providing network connectivity through a network interface controller (NIC) 722, such as a gigabit Ethernet adapter. A NIC 722 may be capable of connecting the computing device 700 to other computing nodes over a network 716. It should be appreciated that multiple NICs 722 may be present in the computing device 700, connecting the computing device to other types of networks and remote computer systems.

The computing device 700 may be connected to a storage device 728 that provides non-volatile storage for the computer. The storage device 728 may store system programs, application programs, other program modules, and data, which have been described in greater detail herein. The storage device 728 may be connected to the computing device 700 through a storage controller 724 connected to the chipset 706. The storage device 728 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a storage device 728 by transforming the physical state of the physical storage units to reflect the information being stored. The specific transformation of a physical state may depend on various factors and on different implementations of this description. Examples of such factors may include, but are not limited to, the technology used to implement the physical storage units and whether the storage device 728 is characterized as primary or secondary storage and the like.

For example, the computing device 700 may store information to the storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may read information from the storage device 728 by detecting the physical states or characteristics of one or more particular locations within the physical storage units.

In addition or alternatively to the storage device 728 described herein, the computing device 700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A storage device, such as the storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The storage device 728 may store other system or application programs and data utilized by the computing device 700.

The storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described herein. The computing device 700 may have access to computer-readable storage media storing computer-executable instructions, which, when executed by the computing device 700, may perform the methods described in relation to FIGS. 4-6.

A computing device, such as the computing device 700 depicted in FIG. 7, may also include an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not include all of the components shown in FIG. 7, may include other components that are not explicitly shown in FIG. 7, or may utilize an architecture completely different than that shown in FIG. 7.

As described herein, a computing device may be a physical computing device, such as the computing device 700 of FIG. 7. A computing node may also include a virtual machine host process and one or more virtual machine instances. Computer-executable instructions may be executed by the physical hardware of a computing device indirectly through interpretation and/or execution of instructions stored and executed in the context of a virtual machine.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as determined data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present embodiments may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method comprising:
receiving a start time for output of a content;
determining a latency between initiation of transcoding and operation of transcoding;
determining, based on the latency between initiation of transcoding and operation of transcoding, a time at which to initiate transcoding of the content, the time occurring before the start time; and
initiating, at the time, transcoding of the content.

2. The method of claim 1, wherein determining the latency between the initiation of transcoding and the operation of transcoding comprises:
determining that at least one transcoder from a plurality of reserved transcoders is available to transcode the content.

3. The method of claim 2, wherein determining the latency between the initiation of transcoding and the operation of transcoding comprises:
determining that the at least one available transcoder needs to be restarted.

4. The method of claim 1, wherein determining the latency between the initiation of transcoding and the operation of transcoding comprises:
determining that at least one transcoder from a plurality of reserved transcoders is not available to transcode the content.

5. The method of claim 4, wherein initiating transcoding of the content comprises: initiating a transcoder associated with a cloud provider to transcode the content.

6. The method of claim 5, wherein the plurality of reserved transcoders are part of a system that is different from the cloud provider.

7. The method of claim 1, further comprising:
receiving a scheduled end time for output of the content;
determining that the content is not complete at the scheduled end time; and
sending, based on determining that the content is not complete at the scheduled end time, an indication that transcoding of the content needs to continue after the scheduled end time.

8. A method comprising:
receiving a content;
determining that at least one transcoder from a plurality of reserved transcoders is not available to transcode the content;
sending, in response to determining that the at least one transcoder from the plurality of reserved transcoders is not available to transcode the content, the content to a transcoder associated with a cloud provider; and
determining, based on a latency between initiation of the transcoder associated with the cloud provider and operation of the transcoder associated with the cloud provider, a time at which to initiate transcoding of the content.

9. The method of claim 8, wherein the plurality of reserved transcoders are part of a system that is different from the cloud provider.

10. The method of claim 8, further comprising:
initiating, at the time, the transcoder associated with the cloud provider to transcode the content, the time occurring before a start time for output of the content.

11. (canceled)

12. The method of claim 8, further comprising:
receiving a scheduled end time for output of the content; and
determining that the content is not complete at the scheduled end time.

13. The method of claim 12, further comprising:
sending, based on determining that the content is not complete at the scheduled end time, to the transcoder associated with the cloud provider, an indication that transcoding of the content needs to continue after the scheduled end time.

14. A method comprising:
receiving a start time for output of a first content;
determining that at least one transcoder from a plurality of reserved transcoders is available to transcode the first content;
initiating, at a first time, the at least one available transcoder to transcode the first content;
receiving a start time for output of a second content;
determining that at least one transcoder from the plurality of reserved transcoders is not available to transcode the second content; and
initiating, at a second time, a transcoder associated with a cloud provider to transcode the second content.

15. The method of claim 14, wherein the difference between the first time and the start time for output of the first content is less than the difference between the second time and the start time for output of the second content.

16. The method of claim 14, wherein the plurality of reserved transcoders are part of a system that is different from the cloud provider.

17. The method of claim 14, further comprising determining the first time by determining a latency between initiation of the at least one available transcoder and operation of the at least one available transcoder.

18. The method of claim 17, wherein determining the latency between initiation of the at least one available transcoder and operation of the at least one available transcoder comprises:
determining that the at least one available transcoder needs to be restarted.

19. The method of claim 14, further comprising determining the second time by determining a latency between initiation of the transcoder associated with the cloud provider and operation of the transcoder associated with the cloud provider.

20. The method of claim 14, wherein initiating the at least one available transcoder to transcode the first content comprises:
restarting the at least one available transcoder.
